(19) United States
(12) Patent Application Publication
(10) Pub. No.: US 2024/0007464 A1
(43) Pub. Date: Jan. 4, 2024

(54) INTEGRATION OF REAL-WORLD AND VIRTUAL-WORLD SYSTEMS

(71) Applicant: BANK OF AMERICA CORPORATION, CHARLOTTE, NC (US)

(72) Inventors: Saurabh Mavani, Lake Hopatcong, NJ (US); Lalit DHAWAN, Cranbury, NJ (US)

(21) Appl. No.: 17/855,779

(22) Filed: Jun. 30, 2022

(51) Int. Cl. H04L 9/40

(52) U.S. Cl. CPC H04L 63/0853; H04L 63/10

(57) ABSTRACT

A system includes a memory, a user device that can be used by a user to enter a virtual environment and a processor coupled to the user device and the memory. The processor is configured to receive a first user credential associated with the first user and authorize a first avatar of the first user to enter the virtual environment. The processor receives a second user credential associated with the user and authorizes the first avatar to enter a virtual interaction room in the virtual environment. The processor receives a request initiated in the virtual interaction room to perform a real-world data interaction and forwards the request to a second processor in a real-world environment. The processor receives an indication that the requested data interaction is completed and, in response, provides an indication to the first avatar in the virtual interaction room that the requested data interaction has been completed.

### TECHNICAL FIELD

The present disclosure relates generally to network communication and information security, and more specifically to integration of real-world and virtual-world systems.

### BACKGROUND

In a network environment, user devices are in data communication with other user devices that may be distributed anywhere in the world. These network environments allow data and information to be shared among these devices. Some of the technical challenges that occur when data is exchanged between devices are controlling data leakage, unauthorized access to data, and preventing malicious activities. Data storing user devices, such as computers, laptops, augmented reality devices, virtual reality devices, and smartphones, are vulnerable to attacks. This vulnerability poses several network security challenges. Existing systems are typically unable to detect a malicious attack until after the attack has occurred. For example, a bad actor may pretend to be another user in a virtual environment which then allows the bad actor to gain access to other users' information.

### SUMMARY

The system and methods implemented by the system as disclosed in the present disclosure provide technical solutions to the technical problems discussed above by allowing a user to perform real-world data interactions in a virtual environment. The disclosed system and methods provide several practical applications and technical advantages.

For example, the disclosed system and methods provide the practical application of performing in a virtual environment one or more data interactions associated with a real-world environment by improving interoperability of real-world and virtual-world systems. As described in accordance with embodiments of the present disclosure, a virtual-world server may be configured to allow a first user to perform in a virtual environment one or more real-world data interactions which would otherwise need to be performed in the real-world environment (e.g., by directly accessing a real-world server). For example, the first user may initiate from the virtual environment (e.g. via first avatar) a transfer of real-world data objects from a first real-world data file to a second real-world data file. Upon receiving the request to transfer the real-world data objects, the virtual-world server may forward the request to the real-world server. The real-world server may receive the request for the transfer from the virtual-world server and complete the requested transfer of real-world data objects from the first real-world data file to the second real-world data file. When the transfer is completed, real-world server may send a confirmation of the completed transfer to the virtual-world server. Virtual-world server may in turn provide an indication in the virtual environment to the first avatar of the first user that the requested real-world transfer of real-world data objects has been completed. By allowing real-world data interactions to be performed in a virtual environment, the disclosed systems and methods offer the convenience to users of performing real-world data interactions in a virtual environment without physically engaging with real-world persons and systems. The ability to perform real-world data interactions in a virtual environment is also beneficial to physically challenged users who are unable to engage with real-world persons and users. Allowing the user to engage with the real-world while in the virtual environment results in the technical advantage of saving networking and processing resources that would otherwise be spent by the user to exit the virtual environment, interact with the real-world infrastructure, perform the real-world interaction, and then return to the virtual environment. Allowing the user to perform real-world data interactions as well as virtual-world data interactions in the same virtual environment saves networking and processing resources that would otherwise be spent in separately accessing the real-world server and the virtual-world server, and switching between these servers.

The disclosed systems and methods provide the additional practical application of controlling access in the virtual environment to user data stored in real-world system. As described in embodiments of the present disclosure, a first user is authorized to access in the virtual environment a portion of the user data stored on the real-world server that is needed to be accessed by the user to perform real-data interactions in the virtual environment. For example, a second user credential is generated and assigned to the first user that provides the first user access to user data stored at the real-world server. Based on a request from the first user to perform one or more real-world data interactions in the virtual environment, the real-world server determines what portion of the user data the user needs access to in the virtual environment and associated this access to the second user credential. The user is required to provide the second user credential in the virtual environment to gain access to the portion of the user data the user is allowed to access in the virtual environment. Controlling access to the real-world user data within the virtual environment by allowing the user to access a portion of the user data and not the entire user data, improves data security within the virtual environment and avoids theft of user data.

Thus, the disclosed system and methods improve data security in the virtual environment as well as in the real-world environment. By improving data security in virtual and real-world environments, the disclosed system and methods generally improve technology related to performing secure data interactions in a virtual environment as well as real-world environment.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system, in accordance with certain aspects of the present disclosure;

FIG. 2 is a block diagram of an embodiment of the first user device used by the system of FIG. 1;

FIG. 3 illustrates a flowchart of an example method for verifying an identity of a user and performing a real-world data interaction within a virtual environment, in accordance with one or more embodiments of the present disclosure;

FIG. 4 illustrates an example schematic diagram of the virtual-world server shown in FIG. 1, in accordance with one or more aspects of the present disclosure; and

FIG. 5 illustrates an example schematic diagram of the real-world server shown in FIG. 1, in accordance with one or more aspects of the present disclosure.

### DETAILED DESCRIPTION

### Example System

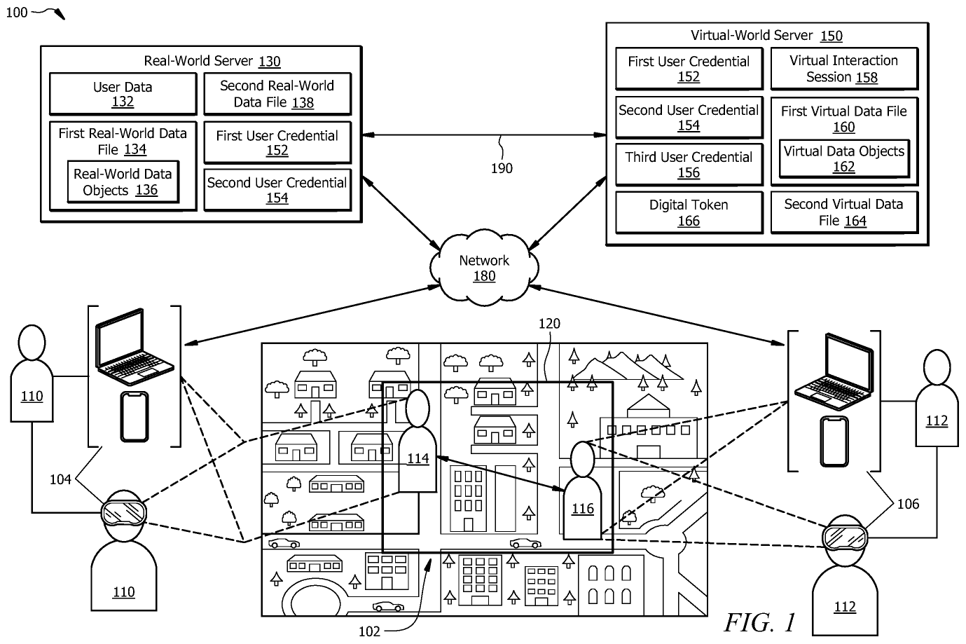

FIG. 1 is a schematic diagram of a system 100, in accordance with certain aspects of the present disclosure. System 100 may include a first user device 104, a second user device 106, real-world server 130, and virtual-world server 150 each connected to a network 180. A first user 110 is associated with the first user device 104 and a second user 112 is associated with the second user device 106. The system 100 may be communicatively coupled to the communication network 180 and may be operable to transmit data between each one of the first user device 104, second user device 106, real-world server 130, and virtual-world server 150 through the communication network 180.

In general, the system 100 may improve interoperability of real-world systems and virtual world systems (e.g., metaverse systems) so that information may be seamlessly shared between these systems to implement data security, authorization of data interactions and other data interactions performed in real-world and virtual environments. For example, user information collected from the user and/or assigned to the user in a real-world environment may be leveraged in a virtual environment 102 (e.g., metaverse environment) to authenticate the first user 110 before allowing the first user 110 to access the real-world user information and perform any kind of action or interaction within the virtual environment 102. This process provides improved information security because it relies on a combination of factors that are associated with both the first user 110 in the real-world and a first avatar 114 that is associated with the first user 110 in the virtual environment 102. It may be noted that the terms “real-world” and “real-world environment” in this disclosure refer to any non-virtual environment where users (e.g., users 110 and 112) can physically interact with real persons and objects. A real-world data interaction may refer to any data interaction performed outside the virtual environment 102 (e.g., a metaverse environment). Further, it may be noted that while certain embodiments of the present disclosure are described in the context of a metaverse environment which is an example of a virtual environment 102, the methods discussed in this disclosure apply to any other virtual environment 102. The terms “virtual environment” and “metaverse environment” are used interchangeably throughout this disclosure. Furthermore, it may be noted that while certain embodiments of this disclosure describe one or more operations in relation to the first user 110, these embodiments apply to any user (e.g., second user 112) connected to network 180.

The first user 110 may access the virtual environment 102 (e.g., a metaverse environment) through the first user device 104. The first user device 104 is configured to display a two-dimensional (2D) or three-dimensional (3D) representation of the virtual environment 102 to the first user 110. Examples of a virtual environment 102 may include, but are not limited to, a graphical or virtual representation of a metaverse, a map, a building interior, a landscape, a fictional location, an alternate reality, or any other suitable type of location or environment. The virtual environment 102 may be configured to use realistic or non-realistic physics for the motion of objects within the virtual environment 102. For example, some virtual environments 102 may be configured to use gravity whereas other virtual environments 102 may not be configured to use gravity. Within the virtual environment 102, each user may be associated with an avatar (such as the first avatar 114 for the first user 110). An avatar is a graphical representation of a user at a virtual location within the virtual environment 102. In embodiments, the virtual location of the avatar may be correlated to the physical location of a user in the real-world environment. Examples of an avatar may include, but are not limited to, a person, an animal, or an object. In some embodiments, the features and characteristics of the avatar may be customizable and user-defined. For example, the size, shape, color, attire, accessories, or any other suitable type of appearance features may be specified by a user. By using an avatar, a user is able to move within the virtual environment 102 to interact with one or more avatars and objects within the virtual environment 102 while independently remaining at a physical location in the real-world environment or being in transit in the real-world environment.

While engaging in the virtual environment 102 via the first avatar 114, the first user 110 may interact with a plurality of other users through a respective avatar. For example, the second user 112 may attempt to engage in an interaction session with the first avatar 114 through a second avatar 116 associated with the second user 112. In the real-world environment, the second user 112 may be physically located at a distance away from the first user 110. The second user 112 may access the virtual environment 102 through the second user device 106 to control the second avatar 116 and attempt to engage in an interaction session with the first user 110 through the first avatar 114.

Before the interaction between the first avatar 114 and second avatar 116 occurs, the virtual-world server 150 may authenticate that the first avatar 114 is associated with the first user 110 and not some unauthorized third-party. For example, the first user 110 may be required to sign into a secure portal that provides access to a data file (e.g., first real-world data file 134 and/or first virtual data file 160) associated with the first user 110. As shown in FIG. 1, the first real-world data file 134 of the first user 110 is stored and managed by the real-world server 130 and the first virtual data file 160 is stored and managed by the virtual-world server 150. In one or more embodiments, the virtual-world server 150 may employ single sign-on (SSO), multifactor authentication, or any other suitable authentication scheme in order to allow the first user 110 access to the first virtual data file 160 and/or the first real-world data file 134. The first virtual data file 160 and the first real-world data file 134 may include virtual data objects 162 and real-world data objects 136 respectively owned by the first user 110. The real-world server 130 and the virtual-world server 150 may store other information related to the first user 110 including, but not limited to, user profile information, account information (e.g., including identity and other details relating to the respective data files 134 and 160), avatar information, digital assets (e.g., respective real-world data objects 136 and virtual data objects 162) information, or any other suitable type of information that is associated with a user within the virtual environment 102 and/or the real-world environment.

Each of the real-world server 130 and the virtual-world server 150 is generally a suitable server (e.g., including a physical server and/or virtual server) operable to store data in a memory and/or provide access to application(s) or other services. One or both of the real-world server 130 and the virtual-world server 150 may be a backend server associated with a particular entity (e.g., organization) that facilitates conducting interactions between entities and one or more users. In other embodiments, one or both of the real-world server 130 and the virtual-world server 150 may be organized in a distributed manner, or by leveraging cloud computing technologies. Real-world server 130 may store information which is primarily used to support data interactions performed in the real-world environment. Virtual-world server 150 may store information which is primarily used to support data interactions performed in the virtual environment 102 (e.g., a metaverse environment). It may be noted that the operations performed by the real-world server 130 and the virtual-world server 150 described in embodiments of the present disclosure may be implemented by a single server.

The communication network 180 may facilitate communication within the system 100. This disclosure contemplates the communication network 180 being any suitable network operable to facilitate communication between the first user device 104, second user device 106, real-world server 130 and the virtual-world server 150. Communication network 180 may include any interconnecting system capable of transmitting audio, video, signals, data, messages, or any combination of the preceding. Communication network 180 may include all or a portion of a local area network (LAN), a wide area network (WAN), an overlay network, a software-defined network (SDN), a virtual private network (VPN), a packet data network (e.g., the Internet), a mobile telephone network (e.g., cellular networks, such as 4G or 5G), a Plain Old Telephone (POT) network, a wireless data network (e.g., WiFi, WiGig, WiMax, etc.), a Long Term Evolution (LTE) network, a Universal Mobile Telecommunications System (UMTS) network, a peer-to-peer (P2P) network, a Bluetooth network, a Near Field Communication network, a Zigbee network, and/or any other suitable network, operable to facilitate communication between the components of system 100. In other embodiments, system 100 may not have all of these components and/or may have other elements instead of, or in addition to, those above.

Each of the user devices (i.e., first user device 104 and second user device 106) may be any computing device configured to communicate with other devices, such as a server (e.g., real-world server 130 and/or virtual-world server 150), databases, etc. through the communication network 180. Each of the user devices may be configured to perform specific functions described herein and interact with one or both of real-world server 130 and the virtual-world server 150, e.g., via its user interfaces. Each of the user devices is a hardware device that is generally configured to provide hardware and software resources to a user. Examples of a user device include, but are not limited to, a virtual reality device, an augmented reality device, a laptop, a computer, a smartphone, a tablet, a smart device, an Internet-of-Things (IoT) device, or any other suitable type of device. The user devices may comprise a graphical user interface (e.g., a display), a touchscreen, a touchpad, keys, buttons, a mouse, or any other suitable type of hardware that allows a user to view data and/or to provide inputs into the user device. Each user device may be configured to allow a user to send requests to one or both of real-world server 130 and the virtual-world server 150, or to another user device.

### Example User Device

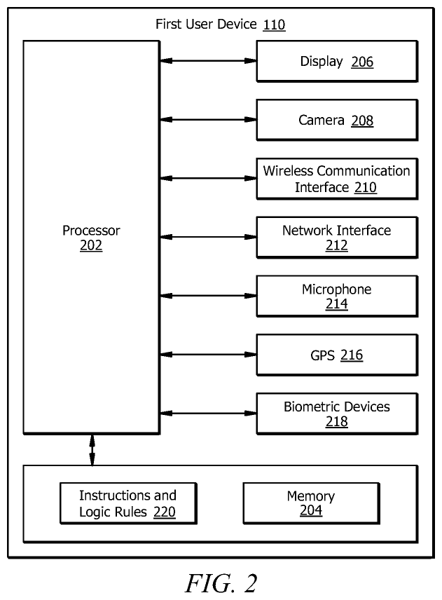

FIG. 2 is a block diagram of an embodiment of the first user device 104 used by the system of FIG. 1. First user device 104 may be configured to display the virtual environment 102 (referring to FIG. 1) within a field of view of the first user 110 (referring to FIG. 1), capture biometric, sensory, and/or physical information of the first user 110 wearing the first user device 104, and to facilitate an electronic interaction between the first user 110 and the second user 112 (referring to FIG. 1).

First user device 104 comprises a processor 202, a memory 204, and a display 206. Further embodiments may include a camera 208, a wireless communication interface 210, a network interface 212, a microphone 214, a global position system (GPS) sensor 216, and/or one or more biometric devices 218. First user device 104 may be configured as shown or in any other suitable configuration. For example, first user device 104 may comprise one or more additional components and/or one or more shown components may be omitted.

The processor 202 comprises one or more processors operably coupled to and in signal communication with memory 204, display 206, camera 208, wireless communication interface 210, network interface 212, microphone 214, GPS sensor 216, and biometric devices 218. Processor 202 is configured to receive and transmit electrical signals among one or more of memory 204, display 206, camera 208, wireless communication interface 210, network interface 212, microphone 214, GPS sensor 216, and biometric devices 218. The electrical signals are used to send and receive data (e.g., images captured from camera 208, virtual objects to display on display 206, etc.) and/or to control or communicate with other devices. Processor 202 may be operably coupled to one or more other devices (for example, the real-world server 130 and/or virtual-world server 150 shown in FIG. 1).

The processor 202 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 202 may be a programmable logic device, a microcontroller, a microprocessor, or any suitable combination of the preceding. The one or more processors are configured to process data and may be implemented in hardware or software. For example, the processor 202 may be 8-bit, 16-bit, 32-bit, 64-bit or of any other suitable architecture. The processor 202 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

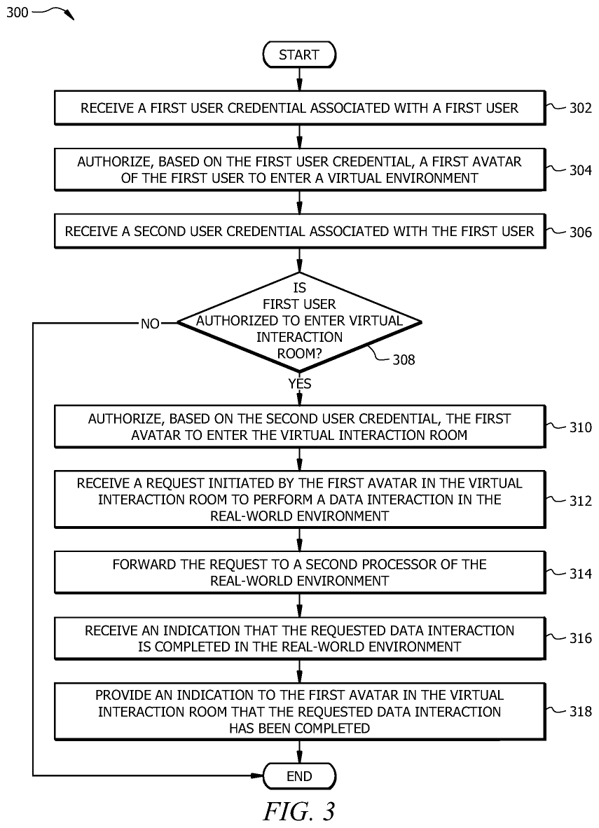

The one or more processors are configured to implement various instructions. For example, the one or more processors are configured to execute instructions to implement the function disclosed herein, such as some or all of those described with respect to FIGS. 1 and 3. For example, processor 202 may be configured to display virtual objects on display 206, detect hand gestures, identify virtual objects selected by a detected hand gesture, capture biometric information of a user, such as first user 110, via one or more of camera 208, microphone 214, and/or biometric devices 218, and communicate via wireless communication interface 210 with the real-world server 130, virtual-world server 150 and/or second user device 106. In some embodiments, the function described herein is implemented using logic units, FPGAs, ASICs, DSPs, or any other suitable hardware or electronic circuitry.

The memory 204 is operable to store any of the information described with respect to FIGS. 1 and 3 along with any other data, instructions, logic, rules, or code operable to implement the function(s) described herein when executed by processor 202. For example, the memory 204 may store the instructions 220. The memory 204 comprises one or more disks, tape drives, or solid-state drives, and may be used as an over-flow data storage device, to store programs when such programs are selected for execution, and to store instructions and data that are read during program execution. Memory 204 is operable to store, for example, information relating to the identity of the user (e.g., at least a portion of user data 132), instructions for performing the functions of first user device 104 described herein, and any other data or instructions. The memory 204 may be volatile or non-volatile and may comprise read-only memory (ROM), random-access memory (RAM), ternary content-addressable memory (TCAM), dynamic random-access memory (DRAM), and static random-access memory (SRAM).

Display 206 is configured to present visual information to a user (for example, first user 110 in FIG. 1) in a virtual reality environment, an augmented reality environment or mixed reality environment. In other embodiments, the display 206 is configured to present visual information to the user as the virtual environment 102 (referring to FIG. 1) in real-time. In an embodiment, display 206 is a wearable optical display (e.g., glasses or a headset) configured to reflect projected images and enables a user to see through the display. For example, display 206 may comprise display units, lens, semi-transparent mirrors embedded in an eye glass structure, a visor structure, or a helmet structure. Examples of display units include, but are not limited to, a cathode ray tube (CRT) display, a liquid crystal display (LCD), a liquid crystal on silicon (LCOS) display, a light emitting diode (LED) display, an active matrix OLED (AMOLED), an organic LED (OLED) display, a projector display, or any other suitable type of display as would be appreciated by one of ordinary skill in the art upon viewing this disclosure. In another embodiment, display 206 is a graphical display on a user device. For example, the graphical display may be the display of a tablet or smart phone configured to display virtual environment 102.

Examples of camera 208 include, but are not limited to, charge-coupled device (CCD) cameras and complementary metal-oxide semiconductor (CMOS) cameras. Camera 208 is configured to capture images of a wearer of first user device 104, such as first user 110. Camera 208 may be configured to capture images continuously, at predetermined intervals, or on-demand. For example, camera 208 may be configured to receive a command from first user 110 to capture an image. In another example, camera 208 is configured to continuously capture images to form a video stream. Camera 208 is communicably coupled to processor 202.

Examples of wireless communication interface 210 include, but are not limited to, a Bluetooth interface, an RFID interface, a near field communication interface, a local area network (LAN) interface, a personal area network interface, a wide area network (WAN) interface, a Wi-Fi interface, a ZigBee interface, or any other suitable wireless communication interface as would be appreciated by one of ordinary skill in the art upon viewing this disclosure. Wireless communication interface 210 is configured to facilitate processor 202 in communicating with other devices. For example, wireless communication interface 210 is configured to enable processor 202 to send and receive signals with other devices, such as second user device 106, the real-world server 130 and/or virtual-world server 150 (referring to FIG. 1). Wireless communication interface 210 is configured to employ any suitable communication protocol.

The network interface 212 is configured to enable wired and/or wireless communications. The network interface 212 is configured to communicate data between the first user device 104 and other network devices, systems, or domain(s). For example, the network interface 212 may comprise a WIFI interface, a local area network (LAN) interface, a wide area network (WAN) interface, a modem, a switch, or a router. The processor 202 is configured to send and receive data using the network interface 212. The network interface 212 may be configured to use any suitable type of communication protocol as would be appreciated by one of ordinary skill in the art.

Microphone 214 is configured to capture audio signals (e.g., voice signals or commands) from a user, such as first user 110. Microphone 214 is configured to capture audio signals continuously, at predetermined intervals, or on-demand. Microphone 214 is communicably coupled to processor 202.

GPS sensor 216 is configured to capture and to provide geographical location information. For example, GPS sensor 216 is configured to provide a geographic location of a user, such as first user 110, employing first user device 104. GPS sensor 216 may be configured to provide the geographic location information as a relative geographic location or an absolute geographic location. GPS sensor 216 may provide the geographic location information using geographic coordinates (i.e., longitude and latitude) or any other suitable coordinate system. GPS sensor 216 is communicably coupled to processor 202.

Examples of biometric devices 218 may include, but are not limited to, retina scanners, fingerprint scanners and facial scanners. Biometric devices 218 are configured to capture information about a person's physical characteristics and to output a biometric signal based on captured information. A biometric signal is a signal that is uniquely linked to a person based on their physical characteristics. For example, biometric device 218 may be configured to perform a retinal scan of the user's eye and to generate a biometric signal for the user based on the retinal scan. As another example, a biometric device 218 is configured to perform a fingerprint scan of the user's finger and to generate a biometric signal for the user based on the fingerprint scan. Biometric device 218 is communicably coupled to processor 202.

Referring back to FIG. 1, in one or more embodiments, one or both of the real-world server 130 and the virtual-world server 150, and one or more user devices (e.g., second user device 106) may be part of an Information Technology (IT) infrastructure of an entity or organization. For example, second user 112 may be a representative of the organization who may use the second user device 106 to enter the virtual environment 102 and virtually interact with one or more users (e.g., first user 110) via the second avatar 116 to provide services to the first user 110.

The real-world server 130 may be configured to allow users (e.g., first user 110) registered with the real-world server 130 to perform one or more data interactions in the real-world environment. Similarly, virtual-world server 150 may be configured to allow users (e.g., first user 110) registered with the virtual-world server 150 to perform one or more data interactions in the virtual environment 102 (e.g., a metaverse environment). In one embodiment, the real-world server 130 and the virtual-world server 150 are owned and/or operated by the same entity/organization. In this context, virtual-world server 150 may be configured to allow users (e.g., first user 110) registered with the real-world server 130 to perform one or more data interactions in the virtual environment 102 (e.g., a metaverse environment). In alternative embodiments, the real-world server 130 and the virtual-world server 150 may be owned and/or operated by different entities/organizations.

In one or more embodiments, as the first user 110 initially registers with the real-world server 130 in the real-world environment, the real-world server 130 may collect several pieces of information from the user including information relating to the identity of the user such as legal name, social security number, biometrics (e.g., fingerprints, retina scans, face ID etc.), residence address, phone numbers, assets owned by the user, and copies of government issued documents (e.g., driver license, state identity card etc.). This information is stored by real-world server 130 as part of user data 132 of the first user 110. In one embodiment, at least a portion of the user data 132 relating to the first user 110 collected in the real-world environment may be stored in the virtual-world server 150. Once the identity of the first user 110 is confirmed and all other information provided by the first user 110 is verified to be correct, the real-world server 130 may generate a first real-world data file 134 for the first user 110 in which the first user 110 may store real-world data objects 136 owned by the first user 110. In one example, the first user 110 may engage in a real-world interaction with a service representative managing the real-world server 130 (e.g., physical interaction at an office location, over phone, voice chat etc.) to provide such information that can be used to register the first user 110 at the real-world server 130 and generate the real-world data file 134 of the first user 110. In another example, the first user 110 may engage in a real-world interaction by accessing a webpage provided and managed by the real-world server 130. Once the first user 110 initiates a registration process via the webpage, the real-world server 130 may walk the first user 110 through several steps in which the first user 110 may be asked to provide information necessary to verify the identity of the first user 110 and register the first user 110 with the real-world server 130.

Information relating to the first real-world data file 134 of the first user 110 may be stored as part of the user data 132 of the first user 110. This information may include, but is not limited to, an identity of the first real-world data file 134, amount of real-world data objects 136 stored in the real-world data file 134, a log of data interactions conducted in relation to the real-world data file 134 and any other information relating to the first real-world data file 134.

Once registered with the real-world server 130, the real-world server 130 may allow the first user 110 to perform one or more data interactions in the real-world environment. For example, a real-world data interaction may include transferring one or more real-world data objects 136 from the first real-world data file 134 of the first user 110 to a second real-world data file 138 of the second user 112. Another example data interaction may include receiving one or more real-world data objects 136 in the first real-world data file 134 of the first user 110 from the second real-world data file 138 of the second user 112. Another example data interaction may include requesting by the first user 110 transfer of real-world data objects from a data file of a second user to a user data file of a third user as part of satisfying an agreement between the first user 110 and the third user. Another example data interaction may include modifying at least a portion of the user data 132 (e.g., user credentials to access the real-world server, phone numbers, residential address, email address, information relating to user assets etc.) stored at the real-world server 130. It may be noted that a data interaction in accordance with embodiments of the present disclosure refers to any interaction in the real-world environment and/or metaverse environment 102 that includes transfer of data between computing nodes (e.g., first user device 104, second user device 106, real-world server 130 and virtual-world server 150).

The first user 110 may additionally register with the virtual-world server 150. In one embodiment, when initially registering with the virtual-world server 150, the first user 110 may provide to the virtual-world server 150 a credential (e.g., username and password) that provides the first user 110 access to the real-world server 130. For example, a single web page or web portal may allow the first user 110 to register with the real-world server 130 as well as the virtual-world server 150. The first user may first register with the real-world server 130 as described above and generate credentials that allow the user access to the real-world server 130 and services provided by the real-world server. Once registered with the real-world server 130, the web portal may offer the first user 110 an option to additionally register with the virtual-world server 150 which may allow the first user 110 to perform data interactions in the virtual environment 102. Registration with the virtual-world server 150 may include generating a first user credential 152 that allows the first user to sign on to the virtual-world server and enter the virtual environment 102 via first avatar 114 of the first user 110. Once registered the virtual-world server 150, the first user 110 may generate a first virtual data file 160 in which the first user 110 may store virtual data objects 162 owned by the first user 110. In one or more embodiments, the first virtual data file 160 of the first user 110 is associated with the first real-world data file 134 of the first user 110. For example, the first virtual data file 160 is a virtual image of the first real-world data file 134, wherein the virtual data objects 162 correspond to the real-world data objects 136. In other words, the first virtual data file 160 is a virtual representation of the first real-world data file 134. In another example, the first virtual data file 160 stores a portion of the real-world data objects 136 in the form of virtual data objects 162.

Once registered with the virtual-world server 150, the virtual-world server 150 may allow the first user 110 to perform one or more virtual data interactions. For example, a virtual data interaction may include transferring one or more virtual data objects 162 from the first virtual data file 160 of the first user 110 to a second virtual data file 164 of the second user 112. Another example data interaction may include receiving one or more virtual data objects 162 in the first virtual data file 160 of the first user 110 from the second virtual data file 164 of the second user 112. Another example data interaction may include requesting by the first user 110 transfer of virtual data objects from a data file of a second user to a data file of a third user as part of satisfying an agreement between the first user 110 and the third user.

In one or more embodiments, a virtual data file (e.g. first virtual data file 160 and second virtual data file 164) is a software application running on a computing node owned and/or operated by the respective user. For example, when the first user 110 desires to receive virtual data objects 162 from the second virtual data file 164 of the second user 112, first user 110 may direct the second user 112 to a unique cryptographic address (e.g., public key) issued by the first virtual data file 160. In one embodiment, the first virtual data file 160 may not itself store the virtual data objects 162 but may store information that points to a location of the virtual data objects 162, for example, on a server (e.g., virtual-world server 150). First virtual data file 160 may be web-based or hardware-based. For example, first virtual data file 160 may be stored in a mobile device or a desktop computer connected to the internet. Additionally or alternatively, first virtual data file 160 may be stored in a device (e.g., USB drive) that is not connected to the network 180.

Data security is important in any system that supports online data interactions between computing nodes of the system. Online data interactions in real-world environments have existed for several decades and robust measures are already in place to ensure data security in real-world systems. However, metaverse technology is relatively new and data security is a challenge in metaverse systems as the development of metaverse related technologies is still at a nascent stage and standardized systems that provide robust data security are not yet in place.

Embodiments of the present disclosure leverage user data collected and/or assigned in a real-world environment for providing data security in a metaverse environment. In general, embodiments of the present disclosure describe techniques that improve interoperability of real-world systems and virtual world systems (e.g., metaverse systems) so that information may be seamlessly shared between these systems to implement data security, authorization of data interactions and other data interactions performed in real-world and virtual environments.

In one or more embodiments, virtual-world server 150 may be configured to use a first user credential 152 collected from the first user 110, generated by the first user 110 or assigned to the first user 110 during real-world data interactions with the first user 110, to verify identity of the first user 110 in the virtual environment 102. Thus, the first user credential 152 provides the first user 110 access to the virtual environment 102. For example, the first user credential 152 may be used by the virtual-world server 150 to verify that the first avatar 114 belongs to and is controlled by the first user 110.

In one example, a retina scan of the first user 110 may have been previously collected from the first user 110 as part of a real-world data interaction with the first user 110. Information relating to the retina scan may have been stored as part of the user data 132. The retina scan of the first user 110 may be used as the first user credential 152. When the first user 110 uses the user device 104 (e.g., VR headset) to enter the virtual environment 102 via first avatar 114, the virtual-world server 150 obtains a retina scan of the first user 110 using a biometric device (e.g., biometric device 218) provided at the user device 104. The retina scan obtained via the user device is compared with the retina scan of the first user 110 stored as part of user data 132 in the real-world server 130. When the two retina scans match, virtual-world server 150 determines that the first avatar 114 is associated with the first user 110 and may authorize and allow the first avatar 114 to enter the virtual environment 102.

In another example, first user credential 152 may include a username and password generated by the first user 110 as part of registering with the real-world server 130. The virtual-world server 150 may allow the first user 110 to use the same username and password to enter the virtual environment 102 via first avatar 114.

Virtual-world server 150 may be configured to allow the first user 110 to perform one or more data interactions associated with the real-world environment in the virtual environment 102. For example, the first user 110 may perform in the virtual environment 102 a transfer of real-world data objects 136 from the first real-world data file 134 to the second real-world data file 138 associated with the second user 112. In another example, the first user 110 may perform in the virtual environment 102 a modification to at least a portion of the user data 132 stored in the real-world server 130.

In one or more embodiments, virtual environment 102 may include one or more virtual interaction rooms 120 designated for use by an entity that owns and/or manages the virtual-world server 150 and the real-world server 130. A virtual interaction room 120 may be a virtual room within the virtual environment 102 that a user (e.g., first user 110, second user 112) registered with the virtual-world server 150 may enter using an avatar of the user (e.g., first avatar 114, second user avatar 116) and perform data interactions managed by the virtual-world server 150.

Virtual-world server 150 may assign and configure a virtual interaction room 120 within the virtual environment 102 for the first user 110 to perform data interactions within the virtual world environment 102. Virtual-world server 150 may be configured to generate a second user credential 154 that provides the first user 110 access to the virtual interaction room 120 within the virtual environment 102. The second user credential may include a passcode, a virtual token, an encrypted key, biometrics, multi-factor authentication or any other form of authentication. In one embodiment, first user 110 first enters the virtual environment 102 (e.g., via first avatar 114) using the first user credential and then enters the virtual interaction room 120 using the second user credential 154. Once the first avatar 114 of the first user 110 has entered the virtual interaction room 120, first user 110 may perform one or more data interactions associated with the real-world environment within the virtual interaction room 120 assigned to the first user 110. In order to perform real-world data interactions in the virtual environment 102, the first user 110 may need to access from the virtual environment 102 user data 132 or portions thereof stored in the real-world server 130. In one embodiment, the second user credential 154 provides the first user 110 access to the user data 132 stored at the real-world server 130. In some cases, the first user 110 may access only a portion of the user data 132 within the virtual interaction room 120 of the virtual environment 102. In such cases, the second user credential 154 may be used to implement access by the first user 110 to the portion of user data 132 the first user 110 is authorized to access within the virtual interaction room 120. In other words, the second user credential 154 provides access to the first user 110 within the virtual interaction room 120 to a portion of the user data 132 the user is authorized to access within the virtual environment 102.

In one or more embodiments, when the user provides the second user credential 154 to enter the virtual interaction room 120, virtual-world server 150 creates a communication channel 190 between the real-world server 130 and the virtual-world server 150 to allow seamless transfer of data between the real-world server 130 and the virtual-world server 150. After entering the virtual interaction room 120, the first user 110 may request to view a portion of the user data 132 within the virtual interaction room 120. In response to receiving the request, virtual-world server 150 may determine based on the second user credential 154 whether the first user 110 is authorized to access the requested portion of the user data 132 from the virtual interaction room 120. For example, the virtual-world server 150 may send a request to access the user data 132 to the real-world server including the second user credential 154 provided by the user to enter the virtual interaction room 120. The real-world server 130 may determine whether the second user credential 154 provides to the first user 110 access to the requested user data 132 within the virtual environment 102. If yes, the real-world server 130 informs the virtual-world server 150 that the first user 110 can access the requested user data 132, provides access to the requested user data 132 and allows the virtual-world server 150 to access the user data 132 via the channel 190. Upon determining that the first user 110 is authorized to access the requested portion of the user data 132 from the virtual interaction room 120, virtual-world server 150 accesses the user data 132 at the real-world server via the channel 190 and transfers the requested portion of the user data 132 via the channel 190. The virtual-world server 150 may present the requested user data to the first user 110 within the virtual interaction room 120.

Virtual-world server 150 may be configured to allow the first user to perform in the virtual environment 102 one or more real-world data interactions which would otherwise need to be performed in the real-world environment (e.g., by directly accessing the real-world server 130). For example, the first user 110 may initiate from the virtual interaction room 120 (e.g. via first avatar 114) a transfer of real-world data objects 136 from the first real-world data file 134 to the second real-world data file 138. Upon receiving the request to transfer the real-world data objects 136, virtual-world server 150 may forward the request to the real-world server 130 (e.g., via communication channel 190). The real-world server 130 may receive the request for transfer from the virtual-world server 150 and complete the requested transfer of real-world data objects 136 from the first real-world data file 134 to the second real-world data file 138. When the transfer is completed, real-world server 130 may send a confirmation of the completed transfer to the virtual-world server 150 (e.g., via communication channel 190). Virtual-world server 150 may in turn provide an indication in the virtual interaction room 120 to the first avatar 114 of the first user 110 that the requested real-world transfer of real-world data objects 136 has been completed.

In one or more embodiments, first user 110 may initiate transfer of real-world data objects 136 from the first real-world user data file 134 to the second real-world data file 138, by transferring a corresponding amount of virtual data objects 162 from the first virtual data file 160 to the second virtual data file 164. As described above, the first virtual data file 160 of the first user 110 is associated with the first real-world data file 134 of the first user 110. In one example, the first virtual data file 160 is a virtual image or representation of the first real-world data file 134, wherein the virtual data objects 162 correspond to the real-world data objects 136. Similarly the second virtual data file 164 may be a virtual image or representation of the second real-world data file 138. Thus, a data interaction performed in the virtual environment 102 (e.g., within the virtual interaction room 120) with respect to the first virtual data file 160 translates to a corresponding data interaction performed with respect to the first real-world data file 134 in the real-world environment. For example, a transfer of ten virtual data objects 162 from the first virtual data file 160 to the second virtual data file 164 results in a corresponding transfer of ten real-world data objects 136 from the first real-world data file 134 to the second real-world data file 138. In one embodiment, when the first user 110 transfers a first amount of virtual data objects 162 from the first virtual data file 160 to the second virtual data file 164, virtual-world server 150 sends a request via the communication channel 190 to the real-world server 130 to transfer the same first amount of real-world data objects 136 from the corresponding first real-world data file 134 to the second real-world data file 138.

The first user 110 may request virtual-world server 150 (e.g., via a representative in the real-world) ahead of time to assign and configure a virtual interaction room 120 for one or more data interactions to be performed in the virtual environment 102. For example, the first user 110 may call (e.g., via phone) a representative (e.g., second user 112) of an entity/organization that owns and/or manages the real-world server 130 to place a request to perform one or more real-world data interactions in the virtual environment 102. For example, the first user 110 may request to perform in the virtual environment 102 a transfer of real-world data objects 136 from the first real-world data file 134 to the second real-world data file 138 of a third user (not shown). In response to receiving the request from the first user 110, the representative (e.g., second user 112) of the entity may access the real-world server 130 and place a formal request on behalf of the first user 110 to perform the requested one or more real-world data interactions in the virtual environment 102. The request placed by the representative/second user 112 may include information relating to the requested one or more real-world data interactions, the information including, but not limited to, one or more of an identity of the first user 110, an identity of the first real-world data file of the first user 110, and user data 132 that needs to be accessible in the virtual environment 102 for completing the requested one or more data interactions. Based on the request received from the second user 112 including the information relating to the requested one or more requested real-world data interactions, real-world server 130 may authorize the first user 110 to perform the requested one or more real-world data interactions in the virtual environment 102. Additionally, real-world server 130 may allow the first user 110 access in the virtual environment 102 to a portion of user data 132 that the first user 110 may need to access in the virtual environment 102 to perform the requested one or more requested real-world data interactions. The real-world server 130 may place a request to the virtual-world server 150 for configuring a virtual interaction room 120 in the virtual environment 102 for the first user 110. The request sent to the virtual-world server 150 may include details of the one or more requested real-world data interactions. In response to receiving the request from the real-world server 130, virtual-world server 150 may configure a virtual interaction room 120 for the first user 110. Configuring the virtual interaction room 120 may include assigning the virtual interaction room 120 to the first user 110 (e.g., from a plurality of virtual interaction rooms designated for the entity within the virtual environment 102) to perform one or more real-world data interactions. Additionally, virtual-world server 150 may generate a second user-credential 154 (e.g., a passcode) that provides the first user 110 access to the virtual interaction room 120 assigned to the first user 110 within the virtual environment 102.

Virtual-world server 150 may send a confirmation back to the real-world server 130 that the virtual interaction room 120 has been configured for the first user 110 and may further include the second user credential 154 in the confirmation. The real-world server 130 may associate second user credential 154 to the portion of the user data 132 that the first user 110 has access to in the virtual environment 102. Thus, the second user credential 154 controls access by the first user 110 to the user data 132. Controlling access to the user data 132 within the virtual environment 102 improves data security within the virtual environment 102 and avoids theft of user data 132. The real-world server 130 may send a message (e.g., email, text message, voice message etc.) to a user device (e.g., first user device 104) of the first user 110 confirming that the virtual interaction room 120 is setup within the virtual environment, wherein the message includes the second user credential 154 which the first user 110 is to use to access the virtual interaction room 120 within the virtual environment 102. Once the virtual interaction room 120 has been setup, the first user 110 may sign on (e.g., using user device 104) to the virtual environment 102 using the first user credential 152 of the first user 110, and then enter the virtual interaction room 120 using the second user credential 154 provided to the first user 110. Once the first user 110 enters the virtual environment 102, the first user 110 may access user data 132 as authorized by the second user credential 154 and perform real-world data interactions as described in the preceding paragraphs.

In one or more embodiments, the first user 110 may request to virtually meet in the virtual environment 102 (e.g., at a requested date and time) with a second user 112. In one embodiment, the second user 112 may be a representative of the entity that manages the real-world server 130. In this case, the second user 112 may request the real-world server 130 to setup a virtual interaction session 158 between the first user 110 and the second user 112 at the requested date and time. This request may include request to access user data 132 within the virtual environment 102. The real-world server 130 may in turn request the virtual-world server 150 to configure a virtual interaction room 120 for the virtual interaction between the first user 110 and the second user 112. As described above, the virtual-world server 150 configures the virtual interaction room 120, generates a second user credential 154 for the first user 110 to access the virtual interaction room 120 and sends a confirmation to the real-world server 130. The real-world server 130 associates the second user credential 154 with user data 132 the first user 110 can access in the virtual interaction room 120, and sends a message to the first user 110 confirming that the virtual interaction has been setup at the requested date and time including the second user credential 154. Once the virtual interaction session 158 has been setup, the first user 110 may sign on (e.g., using user device 104) to the virtual environment 102 using the first user credential 152, and then enter the virtual interaction room 120 using the second user credential 154. The second user 112 may use a third user credential 156 of the second user 112 to enter the virtual interaction room 120. In one embodiment, the third user credential 156 may be generated by the virtual-world server 150 as part of setting up the virtual interaction session 158 between the first user 110 and the second user 112. Once the first user 110 and the second user 112 have entered the virtual interaction room 120, they may interact with each other using their respective avatars 114 and 116. The second user 112 who may be a representative of the entity that owns and manages the real-world server 130 may help the first user 110 to navigate the virtual environment 102 and perform one or more real-world data interactions within the virtual environment 102. This may be particularly useful, when the first user 110 is not technically savvy and/or is not comfortable with navigating within the virtual environment 102.

In one or more embodiments, the first user 110 may need to digitally sign a virtual document within the virtual interaction room 120 as part of performing a real-world data interaction. In this case, the virtual document may be an image or representation of a real-world document that needs to be signed as part of performing the real-world data interaction. For example, the first user 110 may use the first avatar 114 within the virtual interaction room 120 to digitally sign a virtual document. In response to detecting that the first user 110 has digitally signed the virtual document within the virtual interaction room 120 as part of performing a real-world data interaction, the virtual-world server 150 generates a digital token 166 that includes the digital signature of the first user 110. Virtual-world server 150 transfers the token including the digital signature of the first user 110 to the real-world server 130. Virtual-world server 150 may additionally transfer to the real-world server 130 information relating to the real-world data interaction and the virtual document signed by the user. For example, the virtual-world server 150 transfers to the real-world server 130 a copy of the signed virtual document. In one embodiment, the additional information relating to the real-world data interaction and the virtual document may be included in the digital token 166. The real-world server 130 receives the digital token 166, extracts all the information including the digital signature of the first user 110 and digitally signs the real-world document that corresponds to the virtual document.

In an example banking use case, the system and methods disclosed in accordance with embodiments of the present disclosure may allow a user (e.g., first user 110) to perform real-world data interactions within the virtual environment 102. In this context, the real-world server 130 may be owned and/or operated by a bank. The virtual-world server 150 may be operated by the same bank or may be operated by another entity. The first real world-data file 134 may correspond to a real-world bank account of the first user 110 and the real-world data objects 136 may correspond to the real-world funds in the bank account of the first user 110. Similarly, the second real-world data file 138 may correspond to a bank account of another user (e.g., the second user 112). User data 132 may include information relating to the bank account of the first user and other information relating to transactions performed by the first user 110 in relation to the bank account. Thus, in accordance with embodiments of this disclosure, the first user 110 may perform in the virtual environment 102 one or more transactions relating to the user's real-world bank account. For example, the first user 110 may transfer real-world funds from the first user's bank account to a second user's bank account by performing a virtual transfer of corresponding virtual data objects between respective virtual data files of the two users in the virtual environment 102.

FIG. 3 illustrates a flowchart of an example method 300 for verifying an identity of a user (e.g., first user 110) and performing a real-world data interaction within a virtual environment, in accordance with one or more embodiments of the present disclosure. Method 300 may be performed by the virtual-world server 150 shown in FIG. 1.

At operation 302, virtual-world server 150 receives a first user credential 152 associated with the first user 110, wherein the first user credential 152 provides the first user 110 access to the virtual environment 102.

At operation 304, virtual-world server 150 authorizes, based on the first user credential 152, a first avatar 114 of the first user 110 to enter the virtual environment 102.

As described above, virtual-world server 150 may be configured to use a first user credential 152 collected from the first user 110, generated by the first user 110 or assigned to the first user 110 during real-world data interactions with the first user 110, to verify identity of the first user 110 in the virtual environment 102. Thus, the first user credential 152 provides the first user 110 access to the virtual environment 102. For example, the first user credential 152 may be used by the virtual-world server 150 to verify that the first avatar 114 belongs to and is controlled by the first user 110.

In one example, a retina scan of the first user 110 may have been previously collected from the first user 110 as part of a real-world data interaction with the first user 110. Information relating to the retina scan may have been stored as part of the user data 132. The retina scan of the first user 110 may be used as the first user credential 152. When the first user 110 uses the user device 104 (e.g., VR headset) to enter the virtual environment 102 via first avatar 114, the virtual-world server 150 obtains a retina scan of the first user 110 using a biometric device (e.g., biometric device 218) provided at the user device 104. The retina scan obtained via the user device is compared with the retina scan of the first user 110 stored as part of user data 132 in the real-world server 130. When the two retina scans match, virtual-world server 150 determines that the first avatar 114 is associated with the first user 110 and may authorize and allow the first avatar 114 to enter the virtual environment 102.

In another example, first user credential 152 may include a username and password generated by the first user 110 as part of registering with the real-world server 130. The virtual-world server 150 may allow the first user 110 to use the same username and password to enter the virtual environment 102 via first avatar 114.

At operation 306, virtual-world server 150 receives a second user credential 154 associated with the first user 110. The second user credential 154 provides the first avatar 114 access to enter a virtual interaction room 120 in the virtual environment 102. The second user credential 154 further provides the first avatar 114 access to user data 132 associated with the first user 110 from a real-world environment (e.g., from the real-world server 130), wherein the user data 132 is collected from the first user 110 during one or more data interactions with the first user in the real-world environment. The virtual interaction room 120 is designated for use by an entity that owns and/or manages one or both of the real-world server 130 and the virtual-world server 150.

As described above, virtual environment 102 may include one or more virtual interaction rooms 120 designated for use by an entity that owns and/or manages the virtual-world server 150 and/or the real-world server 130. A virtual interaction room 120 may be a virtual room within the virtual environment 102 that a user (e.g., first user 110, second user 112) registered with the virtual-world server 150 may enter using an avatar of the user (e.g., first avatar 114, second user avatar 116) and perform data interactions managed by the virtual-world server 150.

Virtual-world server 150 may assign and configure a virtual interaction room 120 within the virtual environment 102 for the first user 110 to perform data interactions within the virtual world environment 102. Virtual-world server 150 may be configured to generate a second user credential 154 that provides the first user 110 access to the virtual interaction room 120 within the virtual environment 102. The second user credential may include a passcode, a virtual token, an encrypted key, biometrics, multi-factor authentication or any other form of authentication. In one embodiment, first user 110 first enters the virtual environment 102 (e.g., via first avatar 114) using the first user credential and then enters the virtual interaction room 120 using the second user credential 154. Once the first avatar 114 of the first user 110 has entered the virtual interaction room 120, first user 110 may perform one or more data interactions associated with the real-world environment within the virtual interaction room 120 assigned to the first user 110. In order to perform real-world data interactions in the virtual environment 102, the first user 110 may need to access from the virtual environment 102 user data 132 or portions thereof stored in the real-world server 130. In one embodiment, the second user credential 154 provides the first user 110 access to the user data 132 stored at the real-world server 130. In some cases, the first user 110 may access only a portion of the user data 132 within the virtual interaction room 120 of the virtual environment 102. In such cases, the second user credential 154 may be used to implement access by the first user 110 to the portion of user data 132 the first user 110 is authorized to access within the virtual interaction room 120. In other words, the second user credential 154 provides access to the first user 110 within the virtual interaction room 120 to a portion of the user data 132 the user is authorized to access within the virtual environment 102.

At operation 308, virtual-world server 150 determines, based on the second user credential 154, whether the first user 110 is authorized to enter the virtual interaction room 120. Upon determining that the first user 110 is authorized to enter the virtual interaction room 120, method 300 proceeds to operation 310.

At operation 310, virtual-world server 150 permits, based on the second user credential 154, the first avatar 114 to enter the virtual interaction room 120.

At operation 312, virtual-world server 150 receives a request initiated by the first avatar 114 in the virtual interaction room 120 of the virtual environment 102 to perform a data interaction in the real-world environment.

At operation 314, virtual-world server 150 forwards the request to a second processor (e.g., real-world server 130) of the real-world environment.

At operation 316, virtual-world server 150 receives an indication that the requested data interaction is completed in the real-world environment.

At operation 318, virtual-world server 150, in response to the indication that the data interaction is completed in the real-world environment, provides an indication to the first avatar 114 in the virtual interaction room 120 that the requested data interaction has been completed.

As discussed above, virtual-world server 150 may be configured to allow the first user to perform in the virtual environment 102 one or more real-world data interactions which would otherwise need to be performed in the real-world environment (e.g., by directly accessing the real-world server 130). For example, the first user 110 may initiate from the virtual interaction room 120 (e.g. via first avatar 114) a transfer of real-world data objects 136 from the first real-world data file 134 to the second real-world data file 138. Upon receiving the request to transfer the real-world data objects 136, virtual-world server 150 may forward the request to the real-world server 130 (e.g., via communication channel 190). The real-world server 130 may receive the request for transfer from the virtual-world server 150 and complete the requested transfer of real-world data objects 136 from the first real-world data file 134 to the second real-world data file 138. When the transfer is completed, real-world server 130 may send a confirmation of the completed transfer to the virtual-world server 150 (e.g., via communication channel 190). Virtual-world server 150 may in turn provide an indication in the virtual interaction room 120 to the first avatar 114 of the first user 110 that the requested real-world transfer of real-world data objects 136 has been completed.

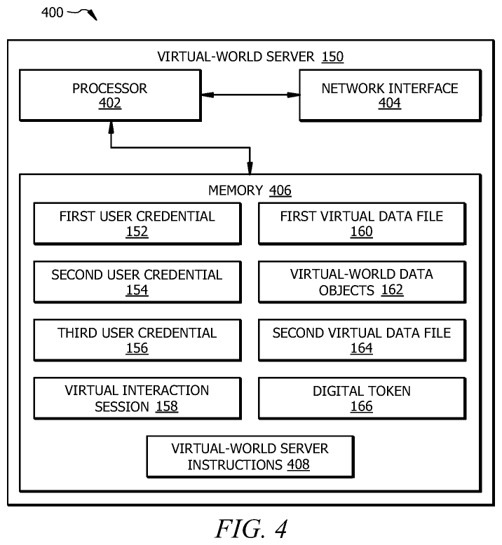

FIG. 4 illustrates an example schematic diagram 400 of the virtual-world server 150 shown in FIG. 1, in accordance with one or more aspects of the present disclosure.

The virtual-world server 150 comprises a processor 402, a memory 406, and a network interface 404. The virtual-world server 150 may be configured as shown in FIG. 4 or in any other suitable configuration.

The processor 402 comprises one or more processors operably coupled to the memory 406. The processor 402 is any electronic circuitry including, but not limited to, state machines, one or more central processing unit (CPU) chips, logic units, cores (e.g. a multi-core processor), field-programmable gate array (FPGAs), application specific integrated circuits (ASICs), or digital signal processors (DSPs). The processor 402 may be a programmable logic device, a microcontroller, a microprocessor, or any suitable combination of the preceding. The processor 402 is communicatively coupled to and in signal communication with the memory 406. The one or more processors are configured to process data and may be implemented in hardware or software. For example, the processor 402 may be 8-bit, 16-bit, 32-bit, 64-bit or of any other suitable architecture. The processor 402 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

The one or more processors are configured to implement various instructions. For example, the one or more processors are configured to execute instructions (e.g., virtual-world server instructions 408) to implement the virtual-world server 150. In this way, processor 402 may be a special-purpose computer designed to implement the functions disclosed herein. In one or more embodiments, the virtual-world server 150 is implemented using logic units, FPGAs, ASICs, DSPs, or any other suitable hardware. The virtual-world server 150 is configured to operate as described with reference to FIG. 3. For example, the processor 402 may be configured to perform at least a portion of the method 300 as described in FIG. 3.

The memory 406 comprises one or more disks, tape drives, or solid-state drives, and may be used as an over-flow data storage device, to store programs when such programs are selected for execution, and to store instructions and data that are read during program execution. The memory 406 may be volatile or non-volatile and may comprise a read-only memory (ROM), random-access memory (RAM), ternary content-addressable memory (TCAM), dynamic random-access memory (DRAM), and static random-access memory (SRAM).

The memory 406 is operable to store the first user credential 152, second user credential 154, third user credential 156, virtual interaction session 158, first virtual data file 160, virtual data objects 162, second virtual data file 164 and the virtual-world server instructions 408. The virtual-world server instructions 408 may include any suitable set of instructions, logic, rules, or code operable to execute the virtual-world server 150.

The network interface 404 is configured to enable wired and/or wireless communications. The network interface 404 is configured to communicate data between the virtual-world server 150 and other devices, systems, or domains (e.g. user devices 104 and 106 and the real-world server 130). For example, the network interface 404 may comprise a Wi-Fi interface, a LAN interface, a WAN interface, a modem, a switch, or a router. The processor 402 is configured to send and receive data using the network interface 404. The network interface 404 may be configured to use any suitable type of communication protocol as would be appreciated by one of ordinary skill in the art.

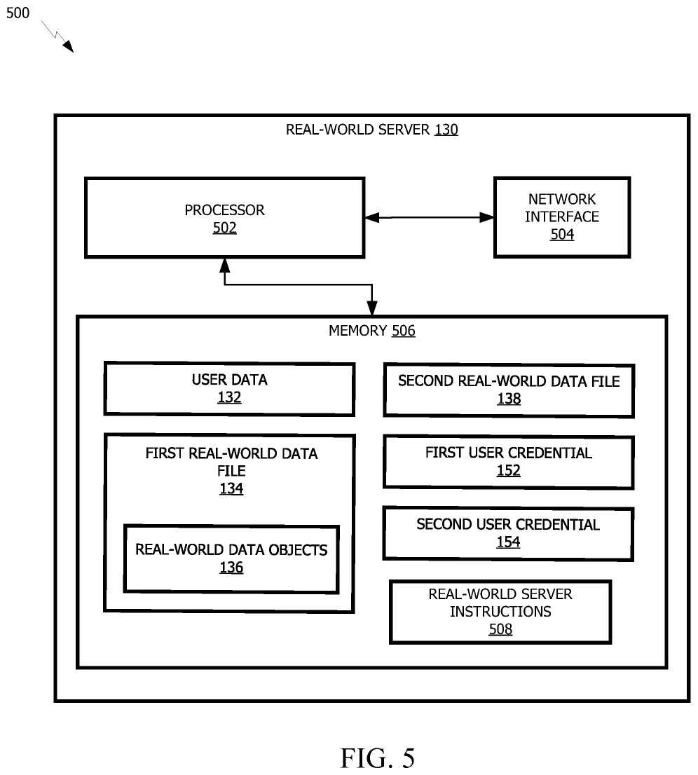

FIG. 5 illustrates an example schematic diagram 500 of the real-world server 130 shown in FIG. 1, in accordance with one or more aspects of the present disclosure.

The real-world server 130 comprises a processor 502, a memory 506, and a network interface 504. The real-world server 130 may be configured as shown in FIG. 5 or in any other suitable configuration.

The processor 502 comprises one or more processors operably coupled to the memory 506. The processor 502 is any electronic circuitry including, but not limited to, state machines, one or more central processing unit (CPU) chips, logic units, cores (e.g. a multi-core processor), field-programmable gate array (FPGAs), application specific integrated circuits (ASICs), or digital signal processors (DSPs). The processor 502 may be a programmable logic device, a microcontroller, a microprocessor, or any suitable combination of the preceding. The processor 502 is communicatively coupled to and in signal communication with the memory 506. The one or more processors are configured to process data and may be implemented in hardware or software. For example, the processor 502 may be 8-bit, 16-bit, 32-bit, 64-bit or of any other suitable architecture. The processor 502 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

The one or more processors are configured to implement various instructions. For example, the one or more processors are configured to execute instructions (e.g., real-world server instructions 508) to implement the real-world server 130. In this way, processor 502 may be a special-purpose computer designed to implement the functions disclosed herein. In one or more embodiments, the real-world server 130 is implemented using logic units, FPGAs, ASICs, DSPs, or any other suitable hardware. The real-world server 130 is configured to operate as described with reference to FIGS. 1 and 3. For example, the processor 502 may be configured to perform at least a portion of the method 300 as described in FIG. 3.

The memory 506 comprises one or more disks, tape drives, or solid-state drives, and may be used as an over-flow data storage device, to store programs when such programs are selected for execution, and to store instructions and data that are read during program execution. The memory 506 may be volatile or non-volatile and may comprise a read-only memory (ROM), random-access memory (RAM), ternary content-addressable memory (TCAM), dynamic random-access memory (DRAM), and static random-access memory (SRAM).

The memory 506 is operable to store information relating to user data 132, first real-world data file 134, real-world data objects 136, second real-world data file 138, first user credential 152, second user credential 154 and the real-world server instructions 508. The real-world server instructions 508 may include any suitable set of instructions, logic, rules, or code operable to execute the real-world server 130.

The network interface 504 is configured to enable wired and/or wireless communications. The network interface 504 is configured to communicate data between the real-world server 130 and other devices, systems, or domains (e.g. user devices 104 and 106 and the virtual-world server 150). For example, the network interface 504 may comprise a Wi-Fi interface, a LAN interface, a WAN interface, a modem, a switch, or a router. The processor 502 is configured to send and receive data using the network interface 504. The network interface 504 may be configured to use any suitable type of communication protocol as would be appreciated by one of ordinary skill in the art.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system comprising:
a user device that can be used by a first user to enter a virtual environment and perform data interactions in the virtual environment;
a memory storing a first user credential and a second user credential associated with the first user; and
at least one processor coupled to the user device and the memory, and configured to:
receive the first user credential associated with the first user, wherein the first user credential provides the first user access to the virtual environment;
authorize, based on the first user credential, a first avatar of the first user to enter the virtual environment;
receive the second user credential associated with the first user, wherein:
the second user credential provides the first avatar access to enter a virtual interaction room in the virtual environment;
the second user credential provides the first avatar access to user data associated with the first user from a real-world environment, wherein the user data is collected from the first user during one or more data interactions with the first user in the real-world environment; and
the virtual interaction room is designated for use by an entity;
authorize, based on the second user credential, the first avatar to enter the virtual interaction room;
receive a request initiated by the first avatar in the virtual interaction room of the virtual environment to perform a data interaction in the real-world environment;
forward the request to a second processor of the real-world environment;
receive an indication that the requested data interaction is completed in the real-world environment; and
in response to the indication that the data interaction is completed in the real-world environment, provide an indication to the first avatar in the virtual interaction room that the requested data interaction has been completed.

2. The system of claim 1, wherein the at least one processor is further configured to:
receive a request initiated in the virtual interaction room of the virtual environment for at least a portion of the user data associated with the first user;
determine, based on the second user credential, whether the first user can access from the virtual environment the requested portion of the user data stored in the real-world environment;
in response to determining that the first user has access to the requested portion of the user data, access the requested portion of the user data in the real-world environment; and
provide the requested portion of the user data to the first avatar in the virtual interaction room.

3. The system of claim 1, wherein the at least one processor is further configured to:
receive in the real-world environment a request from the first user to setup a virtual interaction session with a second user in the virtual environment, wherein the second user is a representative of the entity;
configure the virtual interaction room in the virtual environment for the virtual interaction between the first avatar of the first user and a second avatar of the second user;
generate the second user credential that is to provide the first avatar access to the virtual interaction room in the virtual environment; and
send to the first user in the real-world environment, information relating to the second user credential.

4. The system of claim 3, wherein the at least one processor is further configured to:
receive a third user credential associated with the second user, wherein the third user credential provides the second user access to the virtual interaction room in the virtual environment; and
authorize the second avatar of the second user to enter the virtual interaction room.

5. The system of claim 1, wherein the at least one processor is further configured to:
in response to receiving the second user credential associated with the first user, setup a communication channel between the real-world environment and the virtual environment to transfer data between the real-world environment and the virtual interaction room in the virtual environment.

6. The system of claim 1, wherein the at least one processor is further configured to:
detect that the first avatar has digitally signed a virtual document in the virtual environment;
generate a digital token including the digital signature;
transfer the digital token to the real-world environment; and
digitally sign, based on the digital token, a real-world document that corresponds to the virtual document.

7. The system of claim 1, wherein the at least one processor is further configured to:
receive a request initiated by the first avatar in the virtual interaction room of the virtual environment to transfer one or more virtual data objects from a first virtual data file to a second virtual data file in the virtual environment, wherein the one or more virtual data objects correspond to one or more real-world data objects stored in a first real-world data file; and
forward the request for the transfer to the second processor of the real-world environment;
receive an indication that a transfer has been completed of the one or more real-world data objects from the first real-world data file to a second real-world data file that corresponds to the second virtual data file; and
in response to receiving the indication, indicate to the user that the transfer of the one or more virtual data objects to the second virtual data file has been completed.

8. A method for performing data interactions, comprising:
receiving a first user credential associated with a first user, wherein the first user credential provides the first user access to a virtual environment;
authorizing, based on the first user credential, a first avatar of the first user to enter the virtual environment;
receiving a second user credential associated with the first user, wherein:
the second user credential provides the first avatar access to enter a virtual interaction room in the virtual environment;
the second user credential provides the first avatar access to user data associated with the first user from a real-world environment, wherein the user data is collected from the first user during one or more data interactions with the first user in the real-world environment; and
the virtual interaction room is designated for use by an entity;
authorizing, based on the second user credential, the first avatar to enter the virtual interaction room;
receiving a request initiated by the first avatar in the virtual interaction room of the virtual environment to perform a data interaction in the real-world environment;
forwarding the request to a second processor of the real-world environment;
receiving an indication that the requested data interaction is completed in the real-world environment; and
in response to the indication that the data interaction is completed in the real-world environment, providing an indication to the first avatar in the virtual interaction room that the requested data interaction has been completed.

9. The method of claim 8, further comprising:
receiving a request initiated in the virtual interaction room of the virtual environment for at least a portion of the user data associated with the first user;
determining, based on the second user credential, whether the first user can access from the virtual environment the requested portion of the user data stored in the real-world environment;
in response to determining that the first user has access to the requested portion of the user data, accessing the requested portion of the user data in the real-world environment; and
providing the requested portion of the user data to the first avatar in the virtual interaction room.

10. The method of claim 8, further comprising:
receiving in the real-world environment a request from the first user to setup a virtual interaction session with a second user in the virtual environment, wherein the second user is a representative of the entity;
configuring the virtual interaction room in the virtual environment for the virtual interaction between the first avatar of the first user and a second avatar of the second user;
generating the second user credential that is to provide the first avatar access to the virtual interaction room in the virtual environment; and
sending to the first user in the real-world environment, information relating to the second user credential.

11. The method of claim 10, further comprising:
receiving a third user credential associated with the second user, wherein the third user credential provides the second user access to the virtual interaction room in the virtual environment; and
authorizing the second avatar of the second user to enter the virtual interaction room.

12. The method of claim 8, further comprising:
in response to receiving the second user credential associated with the first user, setting up a communication channel between the real-world environment and the virtual environment to transfer data between the real-world environment and the virtual interaction room in the virtual environment.

13. The method of claim 8, further comprising:
detecting that the first avatar has digitally signed a virtual document in the virtual environment;
generating a digital token including the digital signature;
transferring the digital token to the real-world environment; and
digitally signing, based on the digital token, a real-world document that corresponds to the virtual document.

14. The method of claim 8, further comprising:
receiving a request initiated by the first avatar in the virtual interaction room of the virtual environment to transfer one or more virtual data objects from a first virtual data file to a second virtual data file in the virtual environment, wherein the one or more virtual data objects correspond to one or more real-world data objects stored in a first real-world data file; and
forwarding the request for the transfer to the second processor of the real-world environment;
receiving an indication that a transfer has been completed of the one or more real-world data objects from the first real-world data file to a second real-world data file that corresponds to the second virtual data file; and
in response to receiving the indication, indicating to the user that the transfer of the one or more virtual data objects to the second virtual data file has been completed.

15. An apparatus comprising:
a memory storing a first user credential and a second user credential associated with a first user; and
at least one processor coupled to the memory, and configured to:
receive the first user credential associated with the first user, wherein the first user credential provides the first user access to a virtual environment;
authorize, based on the first user credential, a first avatar of the first user to enter the virtual environment;
receive the second user credential associated with the first user, wherein:
the second user credential provides the first avatar access to enter a virtual interaction room in the virtual environment;
the second user credential provides the first avatar access to user data associated with the first user from a real-world environment, wherein the user data is collected from the first user during one or more data interactions with the first user in the real-world environment; and
the virtual interaction room is designated for use by an entity;
authorize, based on the second user credential, the first avatar to enter the virtual interaction room;
receive a request initiated by the first avatar in the virtual interaction room of the virtual environment to perform a data interaction in the real-world environment;
forward the request to a second processor of the real-world environment;
receive an indication that the requested data interaction is completed in the real-world environment; and
in response to the indication that the data interaction is completed in the real-world environment, provide an indication to the first avatar in the virtual interaction room that the requested data interaction has been completed.

16. The apparatus of claim 15, wherein the at least one processor is further configured to:
receive a request initiated in the virtual interaction room of the virtual environment for at least a portion of the user data associated with the first user;
determine, based on the second user credential, whether the first user can access from the virtual environment the requested portion of the user data stored in the real-world environment;
in response to determining that the first user has access to the requested portion of the user data, access the requested portion of the user data in the real-world environment; and
provide the requested portion of the user data to the first avatar in the virtual interaction room.

17. The apparatus of claim 15, wherein the at least one processor is further configured to:
receive in the real-world environment a request from the first user to setup a virtual interaction session with a second user in the virtual environment, wherein the second user is a representative of the entity;
configure the virtual interaction room in the virtual environment for the virtual interaction between the first avatar of the first user and a second avatar of the second user;
generate the second user credential that is to provide the first avatar access to the virtual interaction room in the virtual environment; and
send to the first user in the real-world environment, information relating to the second user credential.

18. The apparatus of claim 17, wherein the at least one processor is further configured to:
receive a third user credential associated with the second user, wherein the third user credential provides the second user access to the virtual interaction room in the virtual environment; and
authorize the second avatar of the second user to enter the virtual interaction room.

19. The apparatus of claim 15, wherein the at least one processor is further configured to:
in response to receiving the second user credential associated with the first user, setup a communication channel between the real-world environment and the virtual environment to transfer data between the real-world environment and the virtual interaction room in the virtual environment.

20. The apparatus of claim 15, wherein the at least one processor is further configured to:
detect that the first avatar has digitally signed a virtual document in the virtual environment;
generate a digital token including the digital signature;
transfer the digital token to the real-world environment; and
digitally sign, based on the digital token, a real-world document that corresponds to the virtual document.
